(19) United States
(12) Patent Application Publication
(10) Pub. No.: US 2019/0179963 A1
(43) Pub. Date: Jun. 13, 2019

(54) RENDERING SEARCH RESULTS IN A GRAPHICAL USER INTERFACE BASED ON THE DETECTION OF A USER-INITIATED EVENT

(71) Applicant: Facebook, Inc., Menlo Park, CA (US)

(72) Inventors: Ryan Kanoknukulchai, San Francisco, CA (US); Evan Lee Chen, Menlo Park, CA (US); Yinshi Zhang, Hayward, CA (US)

(21) Appl. No.: 15/840,027

(22) Filed: Dec. 13, 2017

(51) Int. Cl. G06F 17/30; G06F 3/0482

(52) U.S. Cl. CPC G06F 17/30867; G06F 3/0488; G06F 3/0482; G06F 17/30994

(57) ABSTRACT

The disclosed computer-implemented method may include (1) receiving, in a graphical user interface displayed on a computing device, data corresponding to a search request for a target search result, (2) rendering, from a storage device, a list of search results for the search request in the graphical user interface, (3) detecting, by the computing device, a user-initiated event corresponding to an identification of the target search result during the rendering of the list of search results in the graphical user interface, and (4) interrupting, by the computing device, the rendering of the list of search results in response to detecting the user-initiated event corresponding to the identification of the target search result in the graphical user interface. Various other methods, systems, and computer-readable media are also disclosed.

### BACKGROUND

Search engines utilized in various applications on client computing devices traditionally include a graphical user interface for receiving user search request data and returning a list of search results. For example, a search engine in a messaging application may receive a search request for displaying a list of names corresponding to a limited amount of text (e.g., the first three letters of a name) entered by a user in a graphical user interface displayed on a client computing device. After receiving the search request, the messaging application may be configured to retrieve all potential search results prior to the search results being rendered in a list for display to a user. For example, a search for the name “John” may yield hundreds of persons having the same or a similar first name. However, delaying the rendering of search results until all potential results have been retrieved may adversely affect the user search experience, particularly in instances where user-desired data may be within an initial portion of the retrieved results, thereby making it unnecessary to render and display the entire list of search results to the user.

### SUMMARY

As will be described in greater detail below, the instant disclosure describes various systems and methods for immediately rendering search results from a data storage for display in a graphical user interface and stopping the rendering in response to detecting a user-initiated event that indicates the currently displayed results include user-desired data.

In one example, a method for rendering search results in a graphical user interface based on the detection of a user-initiated event may include (1) receiving, in a graphical user interface displayed on a computing device, data corresponding to a search request for a target search result, (2) rendering, from a storage device, a list of search results for the search request in the graphical user interface, (3) detecting, by the computing device, a user-initiated event corresponding to an identification of the target search result during the rendering of the list of search results in the graphical user interface, and (4) interrupting, by the computing device, the rendering of the list of search results in response to detecting the user-initiated event corresponding to the identification of the target search result in the graphical user interface.

In some examples, the data corresponding to the search request for a target search result may include (1) receiving partial data in the graphical user interlace, (2) retrieving, from the storage device, type-ahead data to complete the partial data, and (3) displaying the type-ahead data as the data corresponding to the search request in the graphical user interface.

In some examples, the rendering of the list of search results in the graphical user interface may include (1) retrieving the list of search results from the storage device immediately upon receiving the data and (2) displaying the list of search results in the graphical user interface.

In some examples, the detection of the user-initiated event corresponding to an identification of the target search result during the rendering of the list of search results in the graphical user interface may include (1) detecting a first user-initiated event during the rendering of the list of search results, (2) suspending the rendering of the list of search results for a predetermined period after detecting the first user-initiated event, (3) determining whether a confirmation of the first user-initiated event is received during the predetermined period, and (4) detecting that the first user-initiated event is the user-initiated event corresponding to an identification of the target search result upon determining that the confirmation is received during the predetermined period. In this example, the rendering of the list of search results may be resumed upon determining that the confirmation is not received during the predetermined period.

In some examples, the user-initiated event may include movement of a pointing device on a display associated with the computing device. Additionally or alternatively, the user-initiated event may include a touch entry on a display associated with the computing device. Additionally or alternatively, the user-initiated event may include movement of a biometric characteristic associated with a user of the computing device. Additionally or alternatively, the user-initiated event may include a voice input from a user of the computing device.

In addition, a corresponding system for rendering search results in a graphical user interface based on the detection of a user-initiated event may include several modules stored in memory, including (1) a receiving module that receives, in a graphical user interface displayed on a computing device, data corresponding to a search request for a target search result, (2) a rendering module that renders, from a storage device, a list of search results for the search request in the graphical user interface, (3) a detection module that detects a user-initiated event corresponding to an identification of the target search result during the rendering of the list of search results in the graphical user interface, (4) an interruption module that interrupts the rendering of the list of search results in response to detecting the user-initiated event corresponding to the identification of the target search result in the graphical user interface, and (5) at least one physical processor configured to execute the receiving module, the rendering module, the detection module, and the interruption module.

In some examples, the receiving module may receive the data corresponding to the search request for a target search result by (1) receiving partial data in the graphical user interface, (2) retrieving, from the storage device, type-ahead data to complete the partial data, and (3) displaying the type-ahead data as the data corresponding to the search request in the graphical user interface.

In some examples, the rendering module may render the list of search results in the graphical user interface by (1) retrieving the list of search results from the storage device immediately upon receiving the data, and (2) displaying the list of search results in the graphical user interface.

In some examples, the detection module may detect the user-initiated event corresponding to an identification of the target search result during the rendering of the list of search results in the graphical user interface by (1) detecting a first user-initiated event during the rendering of the list of search results, (2) suspending the rendering of the list of search results for a predetermined period after detecting the first user-initiated event, (3) determining whether a confirmation of the first user-initiated event is received during the predetermined period, and (4) detecting that the first user-initiated event is the user-initiated event corresponding to an identification of the target search result upon determining that the confirmation is received during the predetermined period. In this example, the rendering of the list of search results may be resumed upon determining that the confirmation is not received during the predetermined period.

In some examples, the user-initiated event may include detecting movement of a pointing device on a display associated with the computing device. Additionally, or alternatively, the user-initiated event may include a touch entry on a display associated with the computing device. The user-initiated event may also include movement of a biometric characteristic associated with a user of the computing device. Additionally or alternatively, the user-initiated event may include a voice input from a user of the computing device.

In some examples, the above-described method may be encoded as computer-readable instructions on a computer-readable medium. For example, a computer-readable medium may include one or more computer-executable instructions that, when executed by at least one processor of a computing device, may cause the computing device to (1) receive, in a graphical user interface displayed on the computing device, data corresponding to a search request for a target search result, (2) render, from a storage device, a list of search results for the search request in the graphical user interface, (3) detect a user-initiated event corresponding to an identification of the target search result during the rendering of the list of search results in the graphical user interface, and (4) interrupt the rendering of the list of search results in response to detecting the user-initiated event corresponding to the identification of the target search result in the graphical user interface.

In some examples, the computer-executable instructions may cause the computing device to receive the data corresponding to the search request for a target search result by (1) receiving partial data in the graphical user interface, (2) retrieving, from the storage device, type-ahead data to complete the partial data, and (3) displaying the type-ahead data as the data corresponding to the search request in the graphical user interface.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary system for rendering search results in a graphical user interface based on the detection of a user-initiated event.

FIG. 2 is a block diagram of another exemplary system for rendering search results in a graphical user interface based on the detection of a user-initiated event.

FIG. 3 is a block diagram of another exemplary system for rendering search results in a graphical user interface based on the detection of a user-initiated event.

FIG. 4 is a flow diagram of an exemplary method for rendering search results in a graphical user interface based on the detection of a user-initiated event.

FIG. 5 is a block diagram of an exemplary mobile device displaying an exemplary graphical user interface for rendering search results based on the detection of a user-initiated event.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to rendering search results in a graphical user interface based on the detection of a user-initiated event. As will be explained in greater detail below, embodiments of the instant disclosure may be implemented on a computing device that receives a search request in a graphical user interface and may, responsive to the request, render a list of search results from a storage device. The computing device may then detect, during the rendering of the list of search results, a user-initiated event (which may include a pointing device or a screen tap on a touch-sensitive display) corresponding to an identification of a user-desired search result in the list. The computing device may then interrupt the rendering of the list of search results in the graphical user interface.

The disclosed systems and methods may provide one or more advantages over traditional methods for rendering search results in response to a search request made by a user in a client application on a computing device. In traditional systems, if a user submits a search request in a search interface in the client application, the computing device may need to retrieve a complete list of possible search results corresponding to the request (e.g., from a data server) prior to rendering the results in a list for display to the user in a graphical user interface. Under this approach, computing device resources may be significantly taxed (particularly, e.g., in mobile computing devices with limited memory and storage capacity) when a large number of search results is rendered for display. Moreover, since traditional systems do not render the search results until a complete list of search results have been retrieved, the user experience may be adversely affected while waiting for the list (which may include a desired search result near the top of the to be displayed in the client application.

The disclosed systems and methods may immediately render partial search results from a storage device in communication with the computing device hosting the client application, thereby enhancing the user search experience. In one example, a system may include a fast-store (e.g., a cache) from which an initial set of search results is retrieved and a slow-store from which a complete set of search results is retrieved. A list containing the search results may be retrieved from the slow-store by a client application on the computing device and rendered in a graphical user interface until a user-initiated event is detected indicative of the user identifying a desired search result in the partially rendered list. Upon detecting the user-initiated event, the client application may then block the rendering of subsequent search results in the graphical user interface thereby enhancing the user experience. Thus, the disclosed systems and methods may improve the functioning of a computing device by efficiently utilizing processing resources to interrupt the rendering of data in a graphical user interface upon receiving an event (e.g., movement of a pointing device or a screen tap) indicating that user-desired data is displayed, thereby making further data rendering no longer necessary and reducing workload on the computing device. As a result, the processing resources that would typically be used to render a full list of results may be available for other purposes. Thus, an improvement is realized over traditional systems where processing resources continue to be utilized until a complete set of data (e.g., a list of all possible search results responsive to a search query) is rendered on a computing device thereby providing an unsatisfactory user experience. Embodiments of the instant disclosure may also provide a variety of other features and advantages over traditional systems, as explained in the following description of the accompanying figures.

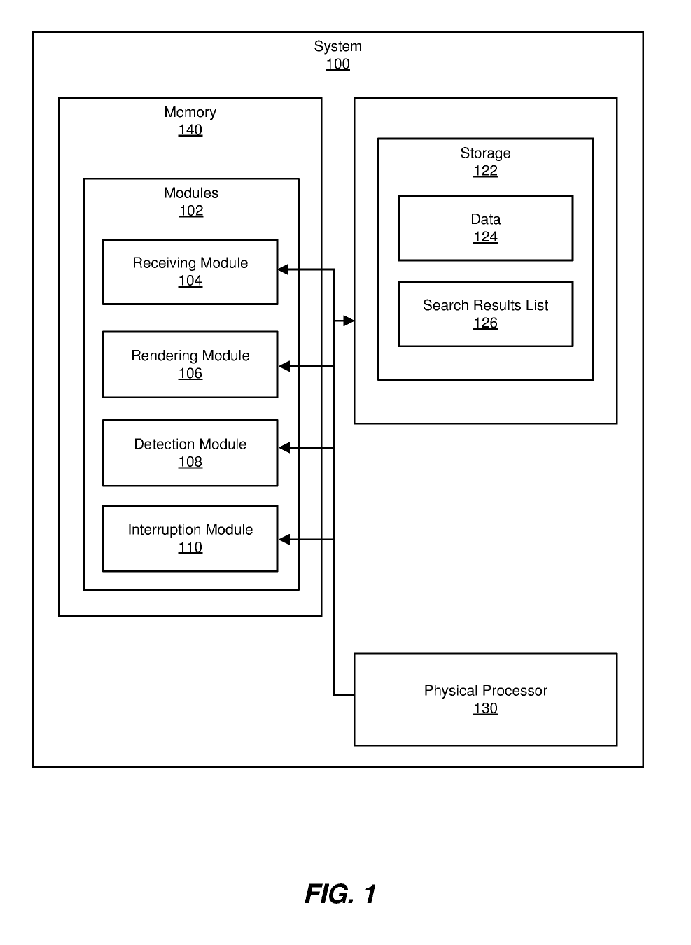

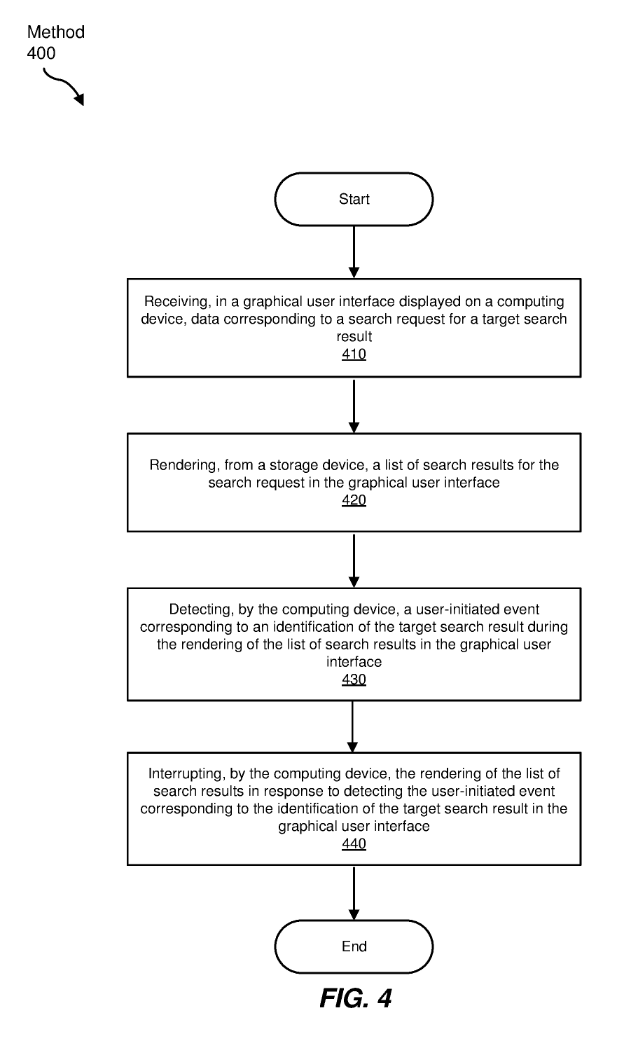

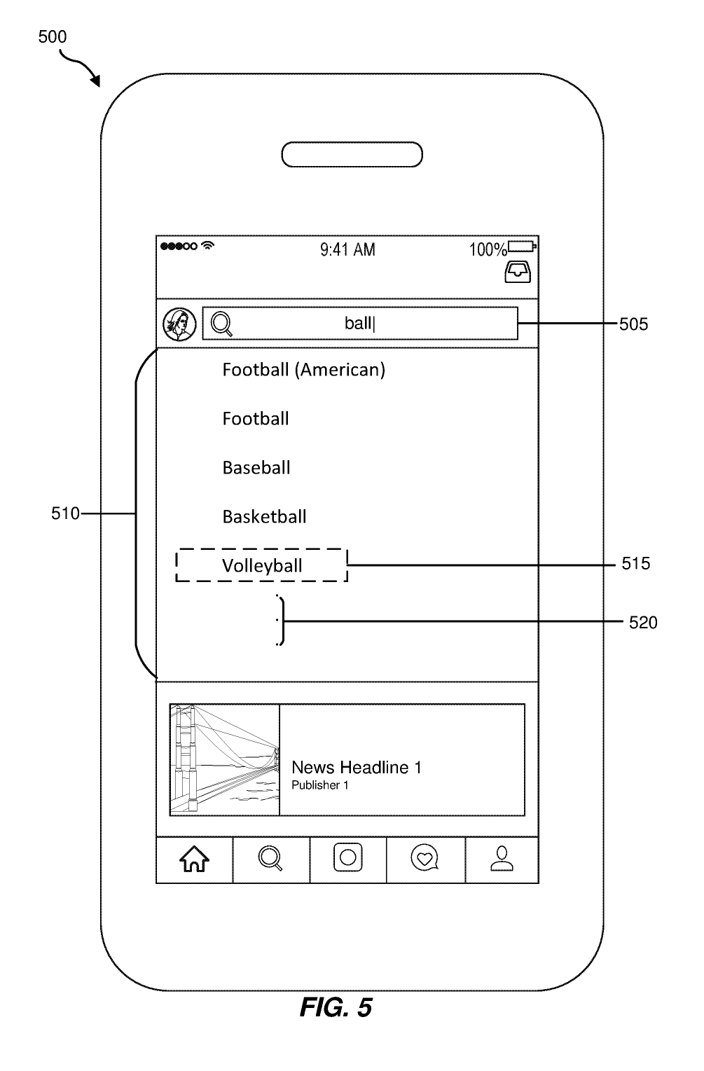

The following will provide, with reference to FIGS. 1-3, detailed descriptions of example systems for rendering search results in a graphical user interface based on the detection of a user-initiated event. Detailed descriptions of a corresponding computer-implemented method and an example mobile device displaying a graphical user interface will also be provided in connection with FIGS. 4-5.

FIG. 1 is a block diagram of an example system 100 for rendering search results in a graphical user interface based on the detection of a user-initiated event. As illustrated in this figure, example system 100 may include one or more modules 102 for performing one or more tasks. As will be explained in greater detail below, modules 102 may include a receiving module 104 that receives data 124 corresponding to a user search request for a target search result. Example system 100 may also include a rendering module 106 that renders, from a storage device, search results list 126 in a graphical user interface. Example system 100 may also include a detection module 108 that detects a user-initiated event corresponding to an identification of the target search result during the rendering of search results list 126 in the graphical user interface. Example system 100 may further include an interruption module 110 that interrupts the rendering of search results list 126 in response to detecting the user-initiated event corresponding to the identification of the target search result in the graphical user interface. Although illustrated as separate elements, one or more of modules 102 in FIG. 1 may represent portions of a single module or application.

In some embodiments, the term “target search result” generally refers to a user-desired result for a search request received within a search interface in a client application (e.g., an instant messaging application or a social media and social networking service application) executing on a computing device. In some examples, the user's search request may be a portion of a name, noun, phrase, topic, etc., and the target search result may be one of multiple possible results generated as a list for display in the client application in response to the user's search request.

In some embodiments, the term “user-initiated event” generally refers to any detectable user interaction with a computing device. As one example, a user-initiated event may be the movement of a pointing device that may be detected by movement of a pointer (e.g., a mouse or touch pointer) or cursor on a display screen of a computing device. As another example, a user-initiated event may be one or more screen taps made by the user on a touch-sensitive display and detected by a computing device. As yet another example, a user-initiated event may be a biometric input (e.g., eye movement) received and detected by a computing device. As yet another example, a user-initiated event may be an audio input (e.g., a user's voice) received and detected by a computing device.

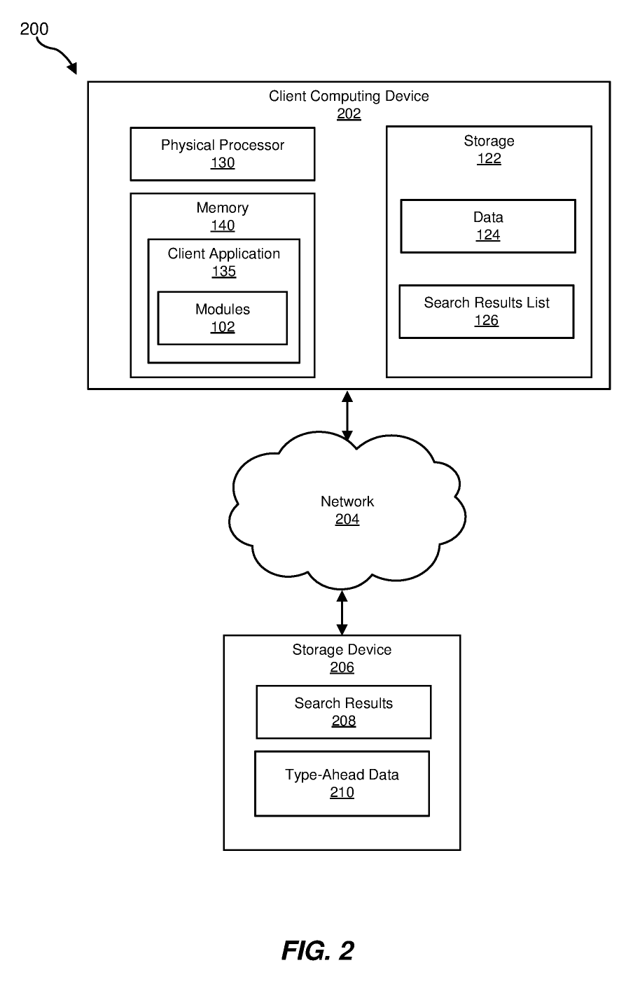

In certain embodiments, one or more of modules 102 in FIG. 1 may represent one or more software applications or programs that, when executed by a computing device, may cause the computing device to perform one or more tasks. For example, one or more of modules 102 may represent a client application that may be an instant messaging application or a social media and social networking service application, capable of receiving and responding to user search requests in a graphical user interface. As another example, and as will be described in greater detail below, one or more of modules 102 may represent modules stored and configured to run on one or more computing devices, such as the devices illustrated in FIG. 2 (e.g., client computing device 202). One or more of modules 102 in FIG. 1 may also represent all or portions of one or more special-purpose computers configured to perform one or more tasks.

As illustrated in FIG. 1, example system 100 may also include one or more memory devices, such as memory 140. Memory 140 generally represents any type or form of volatile or non-volatile storage device or medium capable of storing data and/or computer-readable instructions. In one example, memory 140 may store, load and/or maintain one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

As illustrated in FIG. 1, example system 100 may also include one or more physical processors, such as physical processor 130. Physical processor 130 generally represents any type or form of hardware-implemented processing unit capable of interpreting and/or executing computer-readable instructions. In one example, physical processor 130 may access and/or modify one or more of modules 102 stored in memory 140. Additionally or alternatively, physical processor 130 may execute one or more of modules 102 to facilitate rendering search results in a graphical user interface based on the detection of a user-initiated event.

Examples of physical processor 130 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

As illustrated in FIG. 1, system 100 may also include storage 122 that stores data 124 and a search results list 126. As will be described in greater detail below, data 124 may correspond to a user search request and modules 102 may be utilized to render search results list 126, in response to receiving data 124, in a graphical user interface. Modules 102 may further be utilized to interrupt the rendering of search results list 126 in response to detecting a user-initiated event corresponding to the identification of a target search result in the search results list 126, thereby making efficient use of client computing device processing resources by not continuing to render additional possible search results in the graphical user interface.

Example system 100 in FIG. 1 may be implemented in a variety of ways. For example, all or a portion of example system 100 may represent portions of example system 200 in FIG. 2. As shown in FIG. 2, system 200 may include a client computing device 202 in communication with storage device 206 via a network 204. In one example, all or a portion of the functionality of modules 102 may be performed by client computing device 202, storage device 206, and/or any other suitable computing system. As will be described in greater detail below, one or more of modules 102 from FIG. 1 may, when executed by at least one processor of client computing device 202, enable client computing device 202 to transform network resources. For example, and as will be described in greater detail below, one or more of modules 102 may cause client computing device 202 to (1) receive, at modules 102, data 124 corresponding to a user search request for a target search result, (2) render, from storage device 206 storing search results 208, search results list 126 in a graphical user interface, (3) detect, at modules 102, a user-initiated event corresponding to an identification of the target search result during the rendering of search results list 126 in the graphical user interface, and (4) interrupt, at modules 102, the rendering of search results list 126 in response to detecting the user-initiated event corresponding to the identification of the target search result in the graphical user interface. In some examples, data 124 may include a user search request received as partial data in the graphical user interface which is completed utilizing type-ahead data 210 retrieved by client computing device 202 from storage device 206.

In some embodiments, the term “type-ahead” generally refers to a user interface interaction method to progressively search for and filter through data such as text. As a user inputs data, one or more possible matches for the data may be found and immediately presented to the user. This immediate feedback may enable the user to stop short of inputting an entire word or phrase they were looking for.

Client computing device 202 generally represents any type or form of computing device capable of reading computer-executable instructions. For example, client computing device 202 may include a computing device capable of establishing connections with a remote computing device (e.g., storage device 206) to send and receive data over one or more networks.

Additional examples of client computing device 202 include, without limitation, laptops, tablets, desktops, servers, cellular phones, Personal Digital Assistants (PDAs), multimedia players, embedded systems, wearable devices (e.g., smart watches, smart glasses, etc.), smart vehicles, smart packaging (e.g., active or intelligent packaging), gaming consoles, so-called Internet-of-Things devices (e.g., smart appliances, etc.), variations or combinations of one or more of the same, and/or any other suitable computing device.

Storage device 206 generally represents any type or form of computing device capable of reading computer-executable instructions and storing data. For example, storage device 206 may be a storage server capable of establishing connections with client computing devices (e.g., client computing device 202) to facilitate the client computing devices retrieving search results 208 and type-ahead data 210 over one or more networks. Additional examples of storage device 206 include, without limitation, web servers, security servers, application servers, and/or database servers configured to run certain software applications and/or provide various security, web, and/or database services. Although illustrated as a single entity in FIG. 2, storage device 206 may include and/or represent a plurality of servers that work and/or operate in conjunction with one another.

Network 204 generally represents any medium or architecture capable of facilitating communication or data transfer. In one example, network 204 may facilitate communication between client computing device 202 and storage device 206. In this example, network 204 may facilitate communication or data transfer using wireless and/or wired connections. Examples of network 204 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

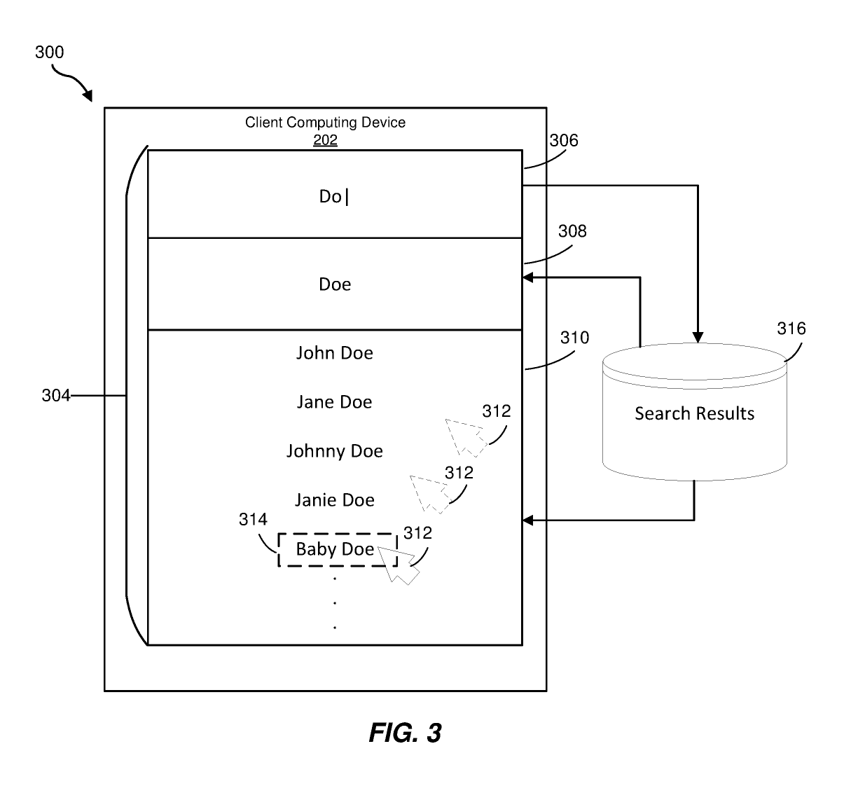

All or a portion of example system 100 may also represent portions of example system 300 in FIG. 3. As shown in FIG. 3, system 300 may include client computing device 202 of FIG. 2 in communication with a data storage 316. In this example, client computing device 202 may be configured to utilize modules 102 to generate a graphical user interface 304 for receiving user search requests and displaying rendered search results retrieved from data storage 316.

In one example, graphical user interface 304 may include a search interface 306 for receiving one or more characters of a user-initiated search request, a type-ahead results window 308 for displaying a search request auto-completed with type-ahead data, and a search results window 310 for displaying search results retrieved from data storage 316 as a list. In this example, a user may enter the first two characters of a name (e.g., “Do”) in search interface 306 which may be auto-completed as “Doe” in type-ahead results window 308.

Upon (or even before) receiving a confirmation of the name in results window 308 as corresponding to the user's desired search term (e.g., the user may press “Enter” on a keyboard or tap a confirmation button (e.g., “Search”) on a touch-sensitive display associated with client computing device 302), modules 102 may initiate a search on the name “Doe” and immediately render all of a possible set of results from data storage 316 in search results window 310. In some examples, a library of search results may be preloaded on data storage 316 to facilitate the quick retrieval and rendering of search results in search results window 310.

As the results are being rendered in search results window 310 (e.g., either from the bottom of window 310 up or the top of window 310 down), modules 102 may detect a user-initiated event corresponding to an identification of a target search result 314. For example, modules 102 may detect movement of mouse pointer 312 after the rendering of the name “Baby Doe” in the list displayed in search results window 310 and then stop the rendering of further search results associated with the search term “Doe.”

In some examples modules 102 may detect multiple user-initiated events to determine that an identification of a target search result has been made by a user. For example, modules 102 may temporarily stop the rendering of the search results after detecting movement of a pointing device and later permanently stop the rendering of the search results after detecting a subsequent user-initiated movement prior to the expiration of a predetermined time period. If a subsequent user-initiated movement s not detected prior to expiration of the predetermined time period, modules 102 may resume the rendering of the search results in search results window 310. In this manner, modules 102 may account for unintentional user-initiated events (e.g., accidental movement of a mouse pointer or a screen tap) that do not correspond to the identification of a target search result. Thus, by utilizing modules 102 to stop the rendering of a list of search results after a target search result has been identified, modules 102 may more efficiently utilize processing resources of computing device 202 by not having to render a complete list of search results responsive to a search request.

FIG. 4 is a flow diagram of an exemplary computer-implemented method 400 for rendering search results in a graphical user interface based on the detection of a user-initiated event. The steps shown in FIG. 4 may be performed by any suitable computer-executable code and/or computing system, including system 100 in FIG. 1, system 200 in FIG. 2, system 300 in FIG. 3, and/or variations or combinations of one or more of the same. In one example, each of the steps shown in FIG. 4 may represent an algorithm whose structure includes and/or is represented by multiple sub-steps, examples of which will be provided in greater detail below.

As illustrated in FIG. 4, at step 410 one or more of the systems described herein may receive, in a graphical user interface displayed on a computing device, data corresponding to a search request for a target search result. For example, receiving module 104 on client computing device 202 in FIG. 2 may receive data 124 corresponding to a user search request for a target search result. Receiving module 104 may receive search request data in a variety always.

In one example, receiving module 104 may receive a complete search term (e.g., a person's first or last name or an organizational name) in a graphical user interface. As another example, receiving module 104 may receive partial data in the graphical user interface, retrieve (from storage device 206) type-ahead data 210 to complete the partial data, and display the type-ahead data as data 124 corresponding to the search request in the graphical user interface.

Receiving module 104 may receive data 124 from a user interaction with computing device 202 in a variety of contexts. For example, receiving module 104 may receive data 124 as text from a user using a physical keyboard in communication with computing device 202, an onscreen keyboard (e.g., via screen taps) on a touch-sensitive display associated with computing device 202, and/or by way of the user's voice over a microphone associated with computing device 202.

At step 420 in FIG. 4, one or more of the systems described herein may render, from a storage device, a list of search results for the search request received in the graphical user interface at step 410. For example, rendering module 106 on client computing device 202 may render, from storage device 206, search results list 126 in the graphical user interface displayed by client computing device 202. Rendering module 106 may render search results list 126 in a variety of ways.

In one example, rendering module 106 may render search results list 126 by retrieving, from search results 208 on storage device 206, results corresponding to the search request and display the retrieved search results as search results list 126 in the graphical user interface immediately upon receiving data 124. In this example, search results 208 may represent a library of search results preloaded onto storage device 206, thereby facilitating immediate retrieval. The library of search results, which may correspond to a variety of user search requests, may include data such as a list of contacts (e.g., people and/or places) registered to an instant messaging, social media, and/or social networking service on which the user has an account.

At step 430 in FIG. 4, one or more of the systems described herein may detect a user-initiated event corresponding to an identification of a target search result during the rendering of the list of search results in the graphical user interface initiated at step 420. For example, detection module 108 on client computing device 202 may detect a user-initiated event during the rendering of search results list 126 in the graphical user interface displayed on client computing device 202. Detection module 108 may detect the user-initiated event in a variety of ways.

In one example, detection module 108 may detect movement of a pointing device (e.g., via movement of a mouse cursor or pointer) on a display associated with computing device 202. Additionally, or alternatively, detection module 108 may detect a touch entry (e.g., screen taps) on a touch-sensitive display associated with computing device 202. Additionally, or alternatively, detection module 108 may detect movement of a biometric characteristic (e.g., eye movement) associated with a user of computing device 202 via a video capture device. Additionally, or alternatively, detection module 108 may detect a voice input from a user of computing device 202 via an audio capture device (e.g., a microphone).

In some examples, detection module 108 may detect multiple user-initiated events corresponding to an identification of the target search result during the rendering of the search results list 126 in the graphical user interface. In one example, detection module 108 may detect a first user-initiated event after the rendering of search results list 126 has been initiated and then suspend the rendering of the search results list 126 for a predetermined period after detecting the first user-initiated event. For example, detection module 108 may detect a screen tap on a display of computing device 202 as search results list 126 is being rendered and then temporarily suspend the rendering for a few seconds. Continuing with this example, detection module 108 may then determine whether a confirmation of the first user-initiated event is received during the predetermined period. For example, detection module 108 may detect a second user-initiated event (e.g., a second screen tap on the display of computing device 202) during the predetermined period and determine the second user-initiated event as confirmation of the first user-initiated event being the user-initiated event corresponding to an identification of the a et search result. In this example, if detection module 108 does not detect a second user-initiated event during the predetermined period (e.g., the first user-initiated event was unintentional with respect to identifying the target search result), then detection module 108 may instruct rendering module 106 to resume the rendering of search results list 126.

At step 440 in FIG. 4, one or more of the systems described herein may interrupt the rendering of the list of search results in response to detecting the user-initiated event corresponding to the identification of the target search result in the graphical user interface. For example, interruption module 110 on client computing device 202 may interrupt the rendering of search results list 126 in response to detecting the user-initiated event corresponding to the identification of the target search result in the graphical user interface at step 430. Interruption module 110 may interrupt the rendering of search results list 126 in a variety of ways.

For example, interruption module 110 may immediately halt the retrieval of further search results 208 corresponding to the search request received at step 410, from storage device 206, so that the last search result currently displayed in the graphical user interface is the target search result. Additionally, interruption module 110 may display an indicator following the target search as a visual confirmation that the rendering of search results list 126 has been interrupted.

FIG. 5 is a block diagram of an exemplary mobile device 500 displaying an exemplary graphical user interface 510 (e.g., in an instant messaging application) for rendering search results based on the detection of a user-initiated event. As shown in FIG. 5, mobile device 500 may include client computing device 202 of FIG. 2. In this example, mobile device 500 be configured to utilize modules 102 to receive a user search request in search interface 505 and generate graphical user interface 510 for displaying rendered search results retrieved from storage device 206.

In one example, search interface 505 may receive one or more characters of a topic (e.g., a sports topic) corresponding to a user-initiated search request. Upon receiving a confirmation of the topic corresponding to the user's desired search term (e.g., the user may press “Search” on an onscreen keyboard of a touch-sensitive display associated with mobile device 500), modules 102 may initiate a search on the topic “ball” and immediately render all of a possible set of results from storage device 206 in graphical user interface 510.

As the results are being rendered in graphical user interface 510, modules 102 may detect a user-initiated event corresponding to an identification of a target search result 515. For example, modules 102 may detect one or more screen taps after the rendering of the topic “Volleyball” in the list displayed in graphical user interface 510 and then stop the rendering of further search results associated with the search term “ball.” In some examples, modules 102 may display an indicator 520 to act as visual feedback to the user that the search results list was interrupted prior to completion following the identification of target search result 515.

As explained above in connection with FIGS. 1-5, one or more of the methods and/or systems described herein may, in response to a user-initiated event on a computing device, render a user-desired search result in a search interface on the computing device without waiting for an entire list of search results to be loaded and rendered from a data storage for display to the user. The computing device may be configured to receive data corresponding to a search request for a user-desired search result in a graphical user interface, render, from a storage device, a list of search results for the search request in the graphical user interface, detect a user-initiated event corresponding to an identification of the user-desired search result during the rendering of the list of search results in the graphical user interface, and interrupt the rendering of the list of search results in response to detecting the user-initiated event. In some examples, the list of search results may be preloaded in the storage device allowing for the immediate retrieval and rendering of the list of search results after receiving the user search request.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some embodiments, the term “memory device” generally represents any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, in some embodiments, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive data to be transformed from a user in a search interface, transform the data to a search request, output a result of the transformation to perform a search for a list of search results corresponding to the search request, and use the result of the transformation to render the list of search results for display in a graphical user interface.

Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media) and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, in a graphical user interface displayed on a computing device, data corresponding to a search request for a target search result;
rendering, from a storage device, a list of search results for the search request in the graphical user interface;
detecting, by the computing device, a user-initiated event corresponding to an identification of the target search result during the rendering of the list of search results in the graphical user interface; and
interrupting, by the computing device, the rendering of the list of search results in response to detecting the user-initiated event corresponding to the identification of the target search result in the graphical user interface.

2. The computer-implemented method of claim 1, wherein receiving, in a graphical user interface displayed on a computing device, data corresponding to a search request for a target search result comprises:
receiving partial data in the graphical user interface;
retrieving, from the storage device, type-ahead data to complete the partial data; and
displaying the type-ahead data as the data corresponding to the search request in the graphical user interface.

3. The computer-implemented method of claim 1, wherein rendering, from the storage device, a list of search results in the graphical user interface comprises:
retrieving the list of search results from the storage device immediately upon receiving the data; and
displaying the list of search results in the graphical user interface.

4. The computer-implemented method of claim 1, wherein detecting, by the computing device, a user-initiated event corresponding to an identification of the target search result during the rendering of the list of search results in the graphical user interface comprises:
detecting a first user-initiated event during the rendering of the list of search results;
suspending the rendering of the list of search results for a predetermined period after detecting the first user-initiated event;
determining whether a confirmation of the first user-initiated event is received during the predetermined period; and
detecting that the first user-initiated event is the user-initiated event corresponding to an identification of the target search result upon determining that the confirmation is received during the predetermined period.

5. The computer-implemented method of claim 4, further comprising resuming the rendering of the list of search results upon determining that the confirmation is not received during the predetermined period.

6. The computer-implemented method of claim 1, wherein detecting, by the computing device, a user-initiated event during the rendering of the list of search results in the graphical user interlace comprises detecting movement of a pointing device on a display associated with the computing device.

7. The computer-implemented method of claim 1, wherein detecting, by the computing device, a user-initiated event during the rendering of the list of search results in the graphical user interface comprises detecting a touch entry on a display associated with the computing device.

8. The computer-implemented method of claim 1, wherein detecting, by the computing device, a user-initiated event during the rendering of the list of search results in the graphical user interface comprises detecting movement of a biometric characteristic associated with a user of the computing device.

9. The computer-implemented method of claim 1, wherein detecting, by the computing device, a user-initiated event during the rendering of the list of search results in the graphical user interface comprises detecting a voice input from a user of the computing device.

10. A system comprising:
a receiving module that receives, in a graphical user interface displayed on a computing device data corresponding to a search request for a target search result;
a rendering module that renders, from a storage device, a list of search results for the search request in the graphical user interface;
a detection module that detects a user-initiated event corresponding to an identification of the target search result during the rendering of the list of search results in the graphical user interface;
an interruption module that interrupts the rendering of the list of search results in response to detecting the user-initiated event corresponding to the identification of the target search result in the graphical user interface; and
at least one physical processor configured to execute the receiving module, the rendering module, the detection module, and the interruption module.

11. The system of claim 10, wherein the receiving module receives the data corresponding to a search request for a target search result by:
receiving partial data in the graphical user interface;
retrieving, from the storage device, type-ahead data to complete the partial data; and
displaying the type-ahead data as the data corresponding to the search request in the graphical user interface.

12. The system of claim 10, wherein the rendering module renders the list of search results in the graphical user interface by:
retrieving the list of search results from the storage device immediately upon receiving the data; and
displaying the list of search results in the graphical user interface.

13. The system of claim 10, wherein the detection module detects the user-initiated event corresponding to an identification of the target search result during the rendering of the list of search results in the graphical user interface by:
detecting a first user-initiated event during the rendering of the list of search results;
suspending the rendering of the list of search results for a predetermined period after detecting the first user-initiated event;
determining whether a confirmation of the first user-initiated event is received during the predetermined period; and
detecting that the first user-initiated event is the user-initiated event corresponding to an identification of the target search result upon determining that the confirmation is received during the predetermined period.

14. The system of claim 13, wherein the rendering of the list of search results is resumed upon determining that the confirmation is not received during the predetermined period.

15. The system of claim 10, wherein the detection r nodule detects the user-initiated event corresponding to an identification of the target search result during the rendering of the list of search results in the graphical user interface by detecting movement of a pointing device on a display associated with the computing device.

16. The system of claim 10, wherein the detection module detects the user-initiated event corresponding to an identification of the target search result during the rendering of the list of search results in the graphical user interface by detecting a touch entry on a display associated with the computing device.

17. The system of claim 10, wherein the detection module detects the user-initiated event corresponding to an identification of the target search result during the rendering of the list of search results in the graphical user interface by detecting movement of a biometric characteristic associated with a user of the computing device.

18. The system of claim 10, wherein the detection module detects the user-initiated event corresponding to an identification of the target search result during the rendering of the list of search results in the graphical user interface by detecting a voice input from a user of the computing device.

19. A computer-readable medium comprising:
computer-executable instructions that, when executed by a physical processor of a computing device, cause the computing device to:
receive, in a graphical user interface displayed on the computing device, data corresponding to a search request for a target search result;
render, from a storage device, a list of search results for the search request in the graphical user interface;
detect a user-initiated event corresponding to an identification of the target search result during the rendering of the list of search results in the graphical user interface; and
interrupt the rendering of the list of search results in response to detecting the user-initiated event corresponding to the identification of the target search result in the graphical user interface.

20. The computer-readable medium of claim 19, wherein the computer-executable instructions cause the computing device to receive, in the graphical user interface, data corresponding to a search request for a target search result by:
receiving partial data in the graphical user interface;
retrieving, from the storage device, type-ahead data to complete the partial data; and
displaying the type-ahead data as the data corresponding to the search request in the graphical user interface.
